(19) United States
(12) Patent Application Publication
(10) Pub. No.: US 2026/0367253 A1
(43) Pub. Date: Nov. 19, 2026

(54) DISTANCE MEASUREMENT APPARATUS AND CONTROL METHOD

(71) Applicant: Panasonic Intellectual Property Management Co., Ltd., Osaka (JP)

(72) Inventor: MASAHIKO TSUKUDA, Osaka (JP)

(21) Appl. No.: 19/731,583

(22) Filed: Jul. 6, 2026

Related U.S. Application Data
(63) Continuation of application No. PCT/JP2024/041058, filed on Nov. 20, 2024.

(30) Foreign Application Priority Data
Jan. 22, 2024 (JP) 2024-007247

(51) Int. Cl. G01S 17/89; G01S 7/497; G01S 7/51; G01S 17/86

(52) U.S. Cl. CPC G01S 17/89; G01S 7/497; G01S 7/51; G01S 17/86

(57) ABSTRACT

This distance measurement apparatus includes a LiDAR, a camera, and a controller. The LiDAR includes a scanner and measures the distance to each point within a scanning range. The camera takes an image within an image-taking range that at least partially overlaps the scanning range. The controller performs pre-measurement using the LiDAR to acquire the distance of at least one point in a region of interest within the image. The controller determines a calibration parameter for calibrating the scanning range of the LiDAR based on the distance of the at least one point. The controller performs re-measurement using the LiDAR with the determined calibration parameter to acquire the distance to each point in the region of interest.

### BACKGROUND

### 1. Technical Field

The present disclosure relates to a distance measurement apparatus and a control method.

### 2. Description of the Related Art

In the related art, the joint use of an image and the distance to an object in the image is desired in some cases. For example, Japanese Unexamined Patent Application Publication No. 2022-101310 discloses the feature of using a ToF sensor and a camera to display a movement path of a person, obtained by the ToF sensor, superimposed on an image taken by the camera. Japanese Unexamined Patent Application Publication No. 2022-101310 indicates that calibration is performed such that a human detection frame obtained from the camera image and a human detection frame obtained from the ToF sensor coincide.

### SUMMARY

When a camera for taking an image and a sensor for measuring distance are used as in the example of calibration described in Japanese Unexamined Patent Application Publication No. 2022-101310, a problem may arise in that the installation positions of the camera and the sensor differ from each other, making it difficult to simply overlay the image and the distance measurement result on top of each other. Therefore, when a pixel in the image is specified, the measured distance corresponding to the pixel may not be accurate. One non-limiting and exemplary embodiment provides, among other things, a distance measurement apparatus capable of more accurately measuring the distance to an object in an image.

In one general aspect, the techniques disclosed here feature a distance measurement apparatus including a LiDAR, a camera, and a controller. The LiDAR includes a scanner and measures the distance to each point within a scanning range. The camera takes an image within an image-taking range that at least partially overlaps the scanning range. The controller acquires the distance of at least one point in a region of interest within the image by pre-measurement using the LiDAR. The controller uses the distance of the at least one point as a basis for determining a calibration parameter for calibrating the scanning range of the LiDAR. The controller uses the determined calibration parameter to acquire the distance to each point in the region of interest by re-measurement using the LiDAR.

It should be noted that general or specific embodiments may be implemented as a system, an apparatus, a method, an integrated circuit, a computer program, or a non-transitory computer-readable recording medium such as a CD-ROM, or any selective combination thereof.

The present disclosure makes it possible to more accurately measure the distance to an object in an image.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIGS. 1A to 1C are schematic diagrams illustrating an installation example of a distance measurement apparatus according to an embodiment;

FIG. 2 is a block diagram illustrating a functional configuration of a controller according to an embodiment;

FIG. 3 is a diagram for explaining differences in distance measurement results in an installation example according to an embodiment;

FIG. 4 is a diagram for explaining differences in distance measurement results in an installation example according to an embodiment;

FIG. 5 is a flowchart illustrating an example of operations by a distance measurement apparatus according to an embodiment;

FIG. 6 is a diagram illustrating an example of a display of a distance measurement apparatus according to an embodiment; and

FIG. 7 is a diagram illustrating an example of a calibration table of a distance measurement apparatus according to an embodiment.

### DETAILED DESCRIPTION

### Underlying Knowledge Forming Basis of the Present Disclosure

In the related art, the joint use of an image and the distance to an object in the image is desired in some cases. For example, Japanese Unexamined Patent Application Publication No. 2022-101310 discloses the feature of using a ToF sensor and a camera to display a movement path of a person obtained by the ToF sensor superimposed on an image taken by the camera. Japanese Unexamined Patent Application Publication No. 2022-101310 indicates that calibration is performed such that a human detection frame obtained from the camera image and a human detection frame obtained from the ToF sensor coincide. When a camera for taking an image and a sensor for measuring distance (hereinafter also referred to as a range sensor) are used as in the above example, a problem may arise in that the installation positions of the camera and the sensor differ from each other, making it difficult to simply overlay the image and the distance measurement result on top of each other.

One conceivable example of an apparatus or the like in which the above problem is anticipated to occur is a distance measurement apparatus that uses a camera and a range sensor, in which a portion is specified within an image taken by the camera, and the distance to the specified portion is measured. In such a distance measurement apparatus, measuring the distance to an object appearing in an image requires that the pixels of the object in the image coincide with the pixels of the object in the distance measurement result. For example, when a pixel in an image is specified but the measured distance corresponding to the pixel is not associated with the specified pixel, the distance will not be accurate. That is, such a distance measurement apparatus cannot be used to specify an object appearing in an image and measure the distance to the object.

Although described in detail later, the closer an object is to the camera and the range sensor, the more susceptible the distance measurement apparatus is to the effect of the discrepancy between a pixel of the object in the image and a pixel of the object in the distance measurement result. Accordingly, in the present disclosure, to provide, among other things, a distance measurement apparatus capable of more accurately measuring the distance to an object in an image, the distance to the object is pre-measured by a range sensor, and the pre-measurement result is used as a basis for outputting a calibration parameter for calibrating the shift between a pixel in the image and a pixel in a distance measurement result. Reconfiguring the range sensor on the basis of the outputted calibration parameter makes it possible to measure the distance to the object more accurately.

A more specific overview of the present disclosure is as follows.

A distance measurement apparatus according to a first aspect of the present disclosure includes a LiDAR, a camera, and a controller. The LiDAR includes a scanner and measures the distance to each point within a scanning range. The camera takes an image within an image-taking range that at least partially overlaps the scanning range. The controller performs pre-measurement using the LiDAR to acquire the distance of at least one point in a region of interest within the image. The controller determines a calibration parameter for calibrating the scanning range of the LiDAR based on the distance of the at least one point. The controller performs re-measurement using the LiDAR with the determined calibration parameter to acquire the distance to each point in the region of interest.

According to such a distance measurement apparatus, the distance to the region of interest obtained by pre-measurement can be utilized, and thus a calibration parameter for calibrating a scanning range according to the distance can be determined. If the determined calibration parameter is then used to calibrate the scanning range, the discrepancy between the region of interest in the image and the region of interest in the distance measurement result is reduced in subsequent distance measurement, thus making it possible to use the distance measurement apparatus to specify a region of interest appearing in an image and measure the distance to an object in the region of interest. Therefore, it is possible to more accurately measure the distance to an object in an image.

A distance measurement apparatus according to a second aspect is such that, in the distance measurement apparatus according to the first aspect, in the determining of the calibration parameter, the controller selects one calibration parameter from a calibration table that includes a plurality of calibration parameter candidates prepared with respect to each distance of the at least one point.

This makes it possible to determine the calibration parameter by using the distance to the region of interest obtained by pre-measurement to select one calibration parameter from a calibration table including a plurality of calibration parameter candidates prepared in advance for each distance.

A distance measurement apparatus according to a third aspect is such that, in the distance measurement apparatus according to the first or second aspect, the controller further causes a display to display the acquired image, and accepts a specification of the region of interest from a user with respect to the displayed image.

This makes it possible to display an image and accept the specification of a region of interest with respect to the image.

A distance measurement apparatus according to a fourth aspect is such that, in the distance measurement apparatus according to any one of the first to third aspects, the pre-measurement is of a lower resolution compared to the re-measurement.

This has the merit of facilitating avoidance of an increase in the amount of data and/or taking a long time for pre-measurement caused by providing more resolution than is necessary for pre-measurement.

A distance measurement apparatus according to a fifth aspect is such that, in the distance measurement apparatus according to the second aspect or the distance measurement apparatus according to the third or fourth aspect referring back to the second aspect, the plurality of calibration parameter candidates correspond respectively to a plurality of distance ranges delimited according to the distance of the at least one point.

This makes it possible to use calibration parameter candidates respectively associated with a plurality of distance ranges in accordance with the distance measurement result of the pre-measurement as the plurality of calibration parameter candidates.

A distance measurement apparatus according to a sixth aspect is such that, in the distance measurement apparatus according to the fifth aspect, the plurality of distance ranges are such that the shorter the distance from the camera, the narrower the range width.

This makes it possible to associate calibration parameter candidates with the plurality of distance ranges so as to be more fine-grained the shorter the distance from the camera.

A distance measurement apparatus according to a seventh aspect is such that, in the distance measurement apparatus according to any one of the first to sixth aspects, the center of the image-taking range of the camera and the center of the scanning range of the LiDAR intersect at a distance that is equal to or greater than 50 times an installation spacing between the camera and the LiDAR.

This makes it possible to more accurately measure the distance to an object in an image in a state in which the camera and the LiDAR are installed under the condition that the center of the image-taking range of the camera and the center of the scanning range of the LiDAR intersect at a distance that is equal to or greater than 50 times the installation spacing between the camera and the LiDAR.

A distance measurement apparatus according to an eighth aspect is such that, in the distance measurement apparatus according to any one of the first to seventh aspects, the at least one point is included in the half of the region of interest that is closer to the LiDAR.

This makes it possible to use the distance to at least one point included in the half of the region of interest that is closer to the LiDAR as the distance measurement result of the pre-measurement.

A control method according to a ninth aspect of the present disclosure is for controlling a LiDAR. The LiDAR includes a scanner and measures the distance to each point within a scanning range. The control method includes: performing pre-measurement using the LiDAR to acquire the distance of at least one point in a region of interest within an image, the scanning range at least partially overlapping an image-taking range of the image; determining a calibration parameter for calibrating the scanning range of the LiDAR based on the distance of the at least one point; and performing re-measurement using the LiDAR with the determined calibration parameter to acquire the distance to each point in the region of interest.

This makes it possible to exhibit effects similar to those of the distance measurement apparatus described above.

Furthermore, these general or specific aspects may also be realized by a system, an apparatus, a method, an integrated circuit, a computer program, or a non-transitory computer-readable recording medium such as a CD-ROM, or any selective combination thereof.

The following describes embodiments specifically with reference to the drawings. Note that the embodiments described hereinafter all illustrate general or specific examples. Features such as numerical values, shapes, materials, components, layout positions and connection states of structural elements, steps, and the ordering of steps indicated in the following embodiments are merely examples, and are not intended to limit the present disclosure. In addition, among the components in the following embodiments, components that are not described in the independent claims are described as arbitrary or optional components. Note that each diagram is a schematic diagram, and does not necessarily illustrate a strict representation. Also, in each diagram, parts of the configuration which are essentially the same are denoted with the same signs, and duplicate description of such parts may be omitted or simplified in some cases.

### Embodiments

### Configuration

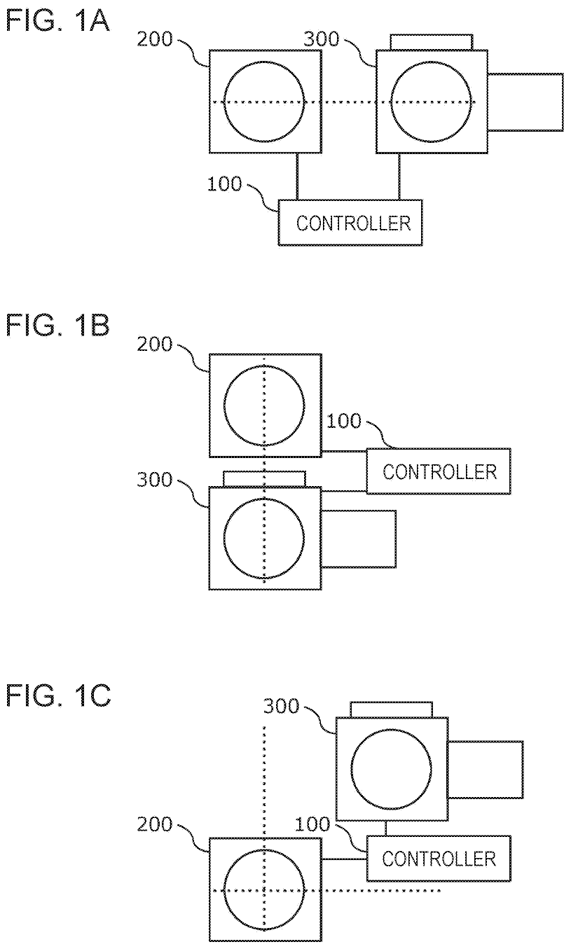

First, an overview and a configuration of a distance measurement apparatus according to an embodiment will be described. FIGS. 1A to 1C are schematic diagrams illustrating an installation example of a distance measurement apparatus according to an embodiment. FIGS. 1A to 1C each illustrate an arrangement of components of a distance measurement apparatus as seen from a direction along the image-taking direction of a camera 200 and a range sensor, namely a light detection and ranging (LiDAR) 300, which are included in the distance measurement apparatus. As illustrated in the diagram, the distance measurement apparatus includes the camera 200, the LiDAR 300, and a controller. The camera 200 is a device that takes an image within an image-taking range (in other words, within a field of view or within an angle of view). The camera 200 uses a photoelectric conversion element to receive light arriving from each position in a two-dimensional plane in the image-taking range and accumulate electric charge, and generates an image corresponding to the two-dimensional plane. The image generated by the camera 200 may be a color image, a grayscale image, or a monochrome image. The camera 200 may be configured to receive any of visible light, infrared light, and ultraviolet light, insofar as the camera 200 can visualize the received light by way of the generated image.

The LiDAR 300 is a range sensor that measures the distance to each position in a three-dimensional space within a scanning range, and uses the distance measurement result to generate a distance point cloud image. The LiDAR 300 generates the distance point cloud image by emitting laser light, measuring the distance to an object on the basis of reflected light of the laser light, and converting the distance to a luminance value and/or a color gradation of each pixel. The LiDAR 300 has a scanner to allow for scanning. The scanner is a device that changes the direction of the light emitted from the LiDAR 300. Any known type of scanner, such as a galvanometer scanner or a polygon scanner, for example, can be used as the scanner.

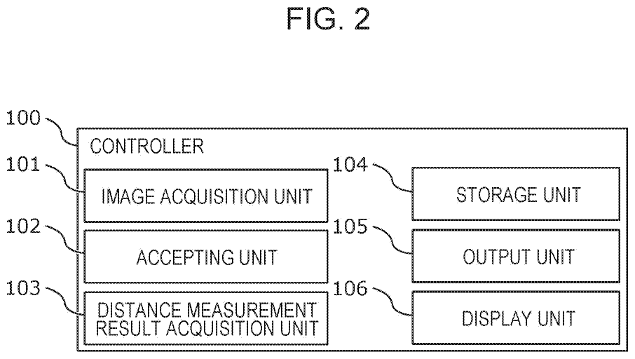

The controller 100 is a device used to control the LiDAR 300. The controller 100 is realized as a result of a prescribed program being executed using a processor, memory, and various input/output hardware, and exhibits the function of each functional unit described below. FIG. 2 is a block diagram illustrating a functional configuration of a controller according to an embodiment. As illustrated in FIG. 2, the controller 100 is provided with an image acquisition unit 101, an accepting unit 102, a distance measurement result acquisition unit 103, a storage unit 104, an output unit 105, and a display unit 106 as functional units.

The image acquisition unit 101 is a functional unit that communicates with the camera 200 and acquires an image taken by the camera 200.

The accepting unit 102 is achieved by, for example, an interface device such as a touch panel, a mouse, and a keyboard, or the like, and a software-implemented signal processing function that processes inputs from the interface device. The accepting unit 102 is a functional unit that accepts the specification of a region of interest in an image. For example, when an image is displayed, the accepting unit 102 accepts an operation for selecting a range of coordinates in at least a portion of the displayed image as the above specification. As a result, the pixels that correspond to the selected coordinates in the image are outputted. The accepting unit 102 is also a functional unit that accepts other input provided by a user. In such a case, the accepting unit 102 accepts input specifying operating settings or the like of the distance measurement apparatus as the other input provided by the user.

The distance measurement result acquisition unit 103 is a functional unit that communicates with the LiDAR 300 and acquires a result of the distance measurement performed by the LiDAR 300, or in other words, a distance point cloud image.

The storage unit 104 is a functional unit that is achieved by semiconductor memory and a software-implemented memory controller. The storage unit 104 is a storage device for storing a calibration table including a plurality of calibration parameter candidates to be described later.

The output unit 105 is a functional unit that determines and outputs one calibration parameter from the above calibration table (in other words, from among the plurality of calibration parameter candidates) on the basis of the distance measurement result.

The display unit 106 is a functional unit that displays the acquired image and the distance measurement result. For example, the display unit 106 includes a display module stacked on or under a touch panel that serves as the accepting unit 102, and is also used to accept direct user input with respect to the displayed image and distance measurement result as well as various software buttons.

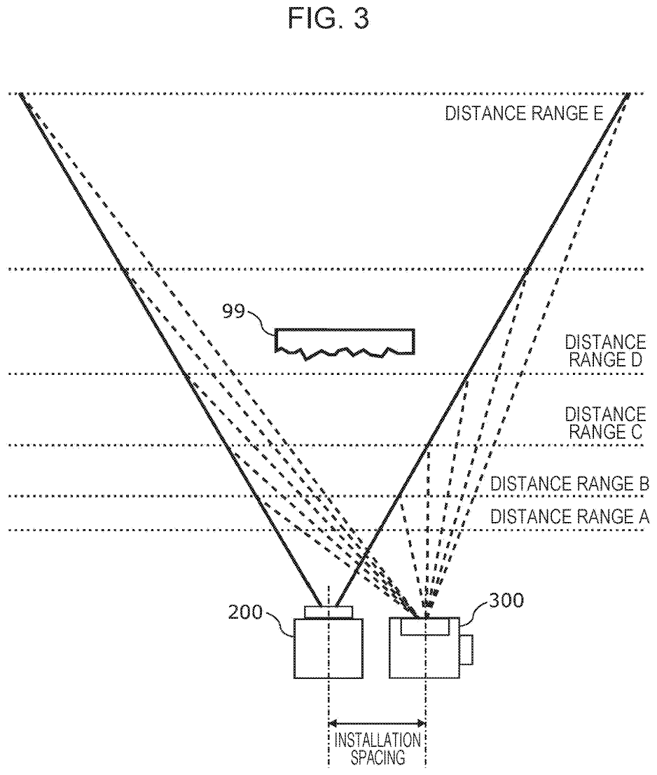

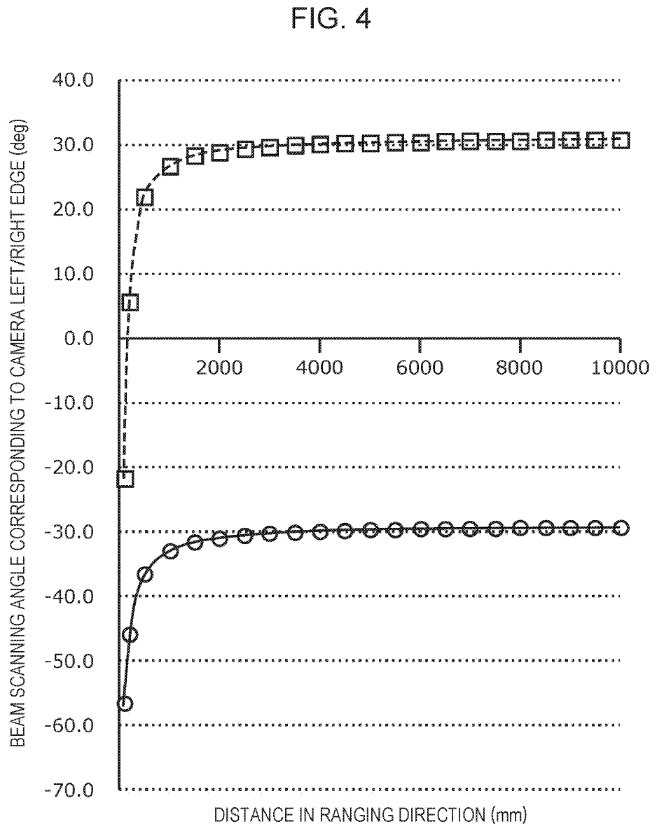

Returning to FIGS. 1A to 1C, when the camera 200 and the LiDAR 300 are disposed, the LiDAR 300 may in some cases be disposed at a position that, with respect to the camera 200, is shifted in the horizontal direction (corresponding to the left-right direction in the plane of the page) of the camera 200, but is not shifted in the vertical direction (corresponding to the up-down direction in the plane of the page) of the camera 200, as illustrated in FIG. 1A, for example. More specifically, this results in an arrangement as illustrated in FIGS. 3 and 4. FIGS. 3 and 4 are diagrams for explaining differences in distance measurement results in an installation example according to an embodiment. The following describes an example in which the LiDAR 300 is disposed on the right side of the camera 200 in the horizontal direction (in other words, the camera 200 is disposed on the left side of the LiDAR 300), as illustrated in FIG. 3. It is assumed that a distance range A, a distance range B, a distance range C, a distance range D, and a distance range E are set in the direction extending away from the camera 200. In the distance range E, the image-taking range of the camera 200 indicated by the thick lines in the diagram and the scanning range of the LiDAR 300 indicated by the dashed lines in the diagram can be superimposed by tilting the scanning range slightly to the left relative to the image-taking range.

In the distance range D, the image-taking range of the camera 200 and the scanning range of the LiDAR 300 can be superimposed by tilting the scanning range further to the left relative to the image-taking range, as compared to the distance range E. In the distance range C, the image-taking range of the camera 200 and the scanning range of the LiDAR 300 can be superimposed by tilting the scanning range further to the left relative to the image-taking range, as compared to the distance range D. In the distance range B, the image-taking range of the camera 200 and the scanning range of the LiDAR 300 can be superimposed by tilting the scanning range further to the left relative to the image-taking range, as compared to the distance range C. In the distance range A, the image-taking range of the camera 200 and the scanning range of the LiDAR 300 can be superimposed by tilting the scanning range further to the left relative to the image-taking range, as compared to the distance range B. More precisely, as illustrated in FIG. 4, the angle of the right edge of the scanning range that corresponds to the right edge of the image-taking range changes on the basis of the distance to an object 99, as indicated by the points plotted using a circle symbol. Likewise, the angle of the left edge of the scanning range that corresponds to the left edge of the image-taking range changes on the basis of the distance to the object 99, as indicated by the points plotted using a square symbol.

In this way, the shorter the distance (to the object 99) from the camera 200, the more the scanning range of the LiDAR 300 is shifted, relative to the image-taking range of the camera 200, to the side (right side) of the camera 200 where the LiDAR 300 is installed. For this reason, calibration may be necessary to superimpose the image-taking range of the camera 200 and the scanning range of the LiDAR 300 such that the shorter the distance from the camera 200, the more the scanning range is tilted to the side (left side) of the LiDAR 300 where the camera 200 is installed. When doing so, if the camera 200 and the LiDAR 300 are housed in the same single enclosure and the installation spacing is fixed, the angle for calibrating each distance range can be preset on the basis of the fixed installation spacing.

Even if the camera 200 and the LiDAR 300 are separate, if the configuration allows for input of the installation spacing after installation, the angle for calibrating each distance range can be calculated on the basis of the inputted installation spacing. In the present embodiment, such knowledge is used as a basis for determining the preset angle for calibrating the LiDAR 300 by identifying the distance range within which the object 99 to be measured is present. For example, in the example illustrated in the diagram, the object 99 is present within the distance range D. In other words, the distance to the object 99 falls within the distance range D, and therefore the scanning range of the LiDAR 300 is calibrated to be a range of angles farther to the left than in the case of the distance range E, and farther to the right than in the case of the distance range C. Note that, as illustrated in the diagram, the shorter the distance from the camera 200, the narrower the range width for each distance range. This corresponds to the relationship whereby the shorter the distance from the camera 200, the greater the shift of the range in a nonlinear manner. That is, defining the distance ranges such that the shorter the distance from the camera 200, the narrower the range width for each distance range has the effect of facilitating suppression of the impact of the nonlinear shift of the range.

Incidentally, as illustrated in FIG. 1B, the LiDAR 300 may also be disposed at a position that, with respect to the camera 200, is not shifted in the horizontal direction of the camera 200, but is shifted in the vertical direction of the camera 200. In this case, calibration may be performed to superimpose the image-taking range of the camera 200 and the scanning range of the LiDAR 300 such that the shorter the distance from the camera 200, the more the scanning range is tilted to the side (upper side) of the LiDAR 300 where the camera 200 is installed. Moreover, as illustrated in FIG. 1C, the LiDAR 300 may also be disposed at a position that, with respect to the camera 200, is shifted in the horizontal direction of the camera 200, and is also shifted in the vertical direction of the camera 200. In this case, calibration may be performed to superimpose the image-taking range of the camera 200 and the scanning range of the LiDAR 300 such that the shorter the distance from the camera 200, the more the scanning range is tilted to the side (lower right side) of the LiDAR 300 where the camera 200 is installed. Even if the positions of the camera 200 and the LiDAR 300 are reversed vertically and/or horizontally, calibration may be similarly applied such that the angle is changed in the opposite direction vertically and/or horizontally.

However, the center of the image-taking range of the camera 200 and the center of the scanning range of the LiDAR 300 intersect at a distance that is equal to or greater than 50 times the abovementioned installation spacing. Beyond this point of intersection, the distance between the centers increases again, strictly speaking, but in the image or the distance image, the spread is no more than a few pixels, and the center of the image-taking range of the camera 200 and the center of the scanning range of the LiDAR 300 can be considered to substantially coincide beyond the point of intersection. Having the center of the image-taking range and the center of the scanning range coincide at some distance away from the camera 200 and the LiDAR 300 in this way has the merit of facilitating avoidance of a situation in which the camera 200 and the LiDAR 300 are disposed with an installation spacing that cannot be addressed by calibration.

### Operations

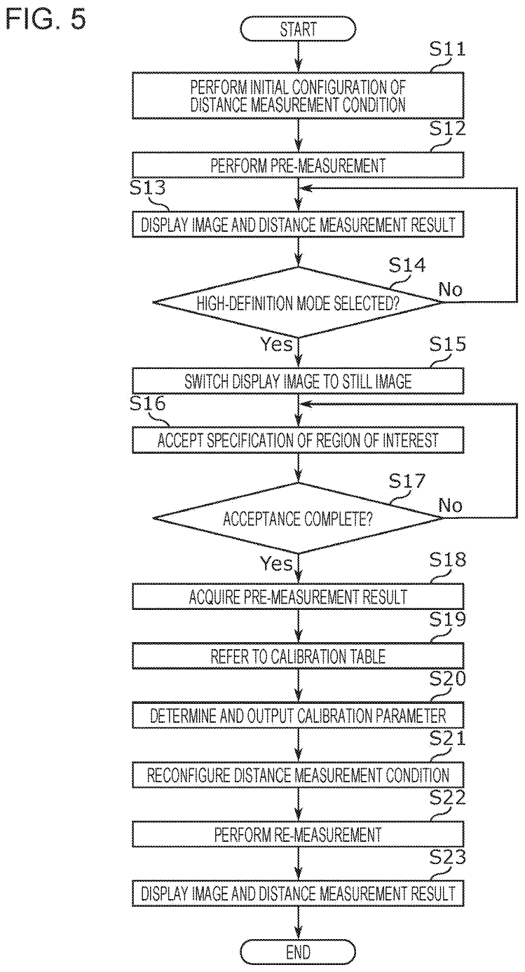

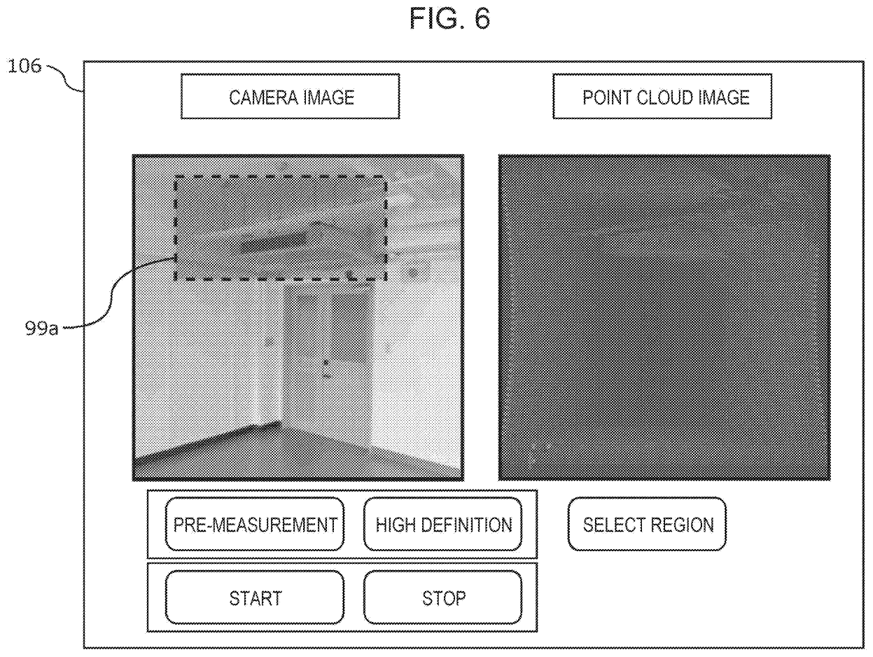

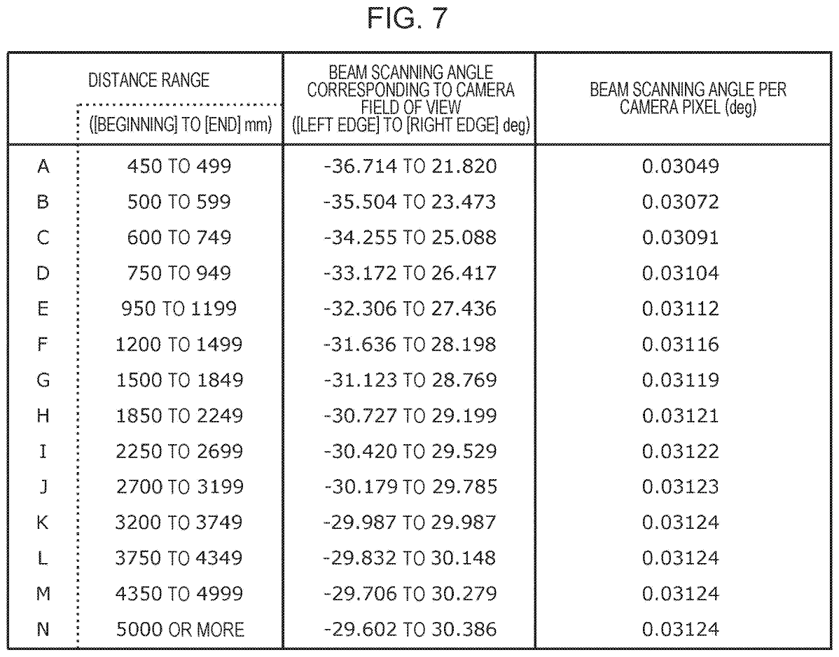

The following refers to FIGS. 5 to 7 to describe operations by the distance measurement apparatus described above, with particular focus on operations by the controller 100. FIG. 5 is a flowchart illustrating an example of operations by a distance measurement apparatus according to an embodiment. FIG. 6 is a diagram illustrating an example of a display of a distance measurement apparatus according to an embodiment. FIG. 7 is a diagram illustrating an example of a calibration table of a distance measurement apparatus according to an embodiment.

First, the controller 100 performs initial configuration of a distance measurement condition on the basis of user input and/or a previous configuration (for example, a factory default configuration of the distance measurement apparatus) (step S11). If the user performs an action such as pressing the “Pre-measurement” button illustrated in FIG. 6, pre-measurement is initiated (step S12). Pre-measurement involves the acquisition of an image as a result of the camera 200 taking an image within the image-taking range, and the acquisition of a distance image as a result of the LiDAR 300 measuring distance within the scanning range. The pre-measurement at this time is distance measurement for determining a distance range based on the distance to the object 99, and as such, some degree of distance shift in the distance measurement result is tolerated. The pre-measurement is performed continuously, and a plurality of images and distance images that are continuous in the time domain are acquired. The distance image to be acquired at this time may be of a resolution sufficient to allow the user to specify a region of interest. Furthermore, since distance measurements that are continuous in the time domain may be necessary, a distance image of relatively low resolution is acquired. Specifically, distance measurement is performed once every five pixels in each of the vertical and horizontal directions to acquire a distance image of 1/25th resolution.

Next, the acquired image and the low-resolution distance image obtained as the distance measurement result are displayed (step S13). As illustrated in FIG. 6, a “camera image”, that is, the image, and a “point cloud image”, that is, the low-resolution distance image, are displayed on the display unit 106. Thereafter, it is ascertained whether or not the user has pressed the “high definition” button illustrated in FIG. 6, according to which it is ascertained whether or not a high-definition mode has been selected (step S14). If it is ascertained that the “high definition” button has not been pressed and the high-definition mode has not been selected (step S14, No), the flow returns to step S13, and the process is repeated.

On the other hand, if it is ascertained that the “high definition” button has been pressed and the high-definition mode has been selected (step S14, Yes), the display unit 106 freezes the currently displayed image on the image at the time when the “high definition” button was pressed, thus switching to a still image (step S15). The accepting unit 102 then accepts the specification of a region of interest by the user, which is achieved by having the user select a range, such as the selection range 99a illustrated in FIG. 6, that is at least a portion of the still image (step S16). If the user presses the “select region” button illustrated in FIG. 6, for example, the selected region is finalized as the specified region of interest. That is, by ascertaining whether or not the “select region” button has been pressed, it is ascertained whether or not acceptance is complete (step S17). If it is ascertained that the “select region” button has not been pressed and acceptance is not complete (step S17, No), the flow returns to step S16, and the process is repeated.

On the other hand, if it is ascertained that the “select region” button has been pressed and acceptance is complete (step S17, Yes), a distance image of the region of interest in the pre-measurement is acquired (step S18). The output unit 105 acquires the distance for at least one point within the region of interest. For example, the output unit 105 may acquire the average of the distances for all pixels in the region of interest as the abovementioned distance for at least one point, or may acquire the distance for a representative point, such as the closest pixel, from among all pixels in the region of interest as the abovementioned distance for at least one point. Also, in the pre-measurement, since calibration has not been performed yet, the distance on the side closer to the camera 200 relative to the LiDAR 300 within the region of interest may not be accurate in some cases. Conversely, the output unit 105 may narrow down the region of interest within the image to the region on the side closer to the LiDAR 300 to determine and acquire the average of the distances for all pixels or the distance for a representative point as the distance.

Next, the output unit 105 accesses the storage unit 104 and references the calibration table (step S19). The output unit 105 uses the at least one distance acquired as mentioned above to determine and output a calibration parameter (step S20). As illustrated in FIG. 7, the calibration table contains a plurality of calibration parameter candidates. Specifically, one calibration parameter is prepared for each distance range. As illustrated in the table, each calibration parameter includes a scanning angle defined by the left and right edges of the scanning range (because in this case the camera 200 and the LiDAR 300 are shifted in the horizontal direction) with respect to the distance range.

Each calibration parameter also includes the magnitude of the scanning angle corresponding to one pixel in the left-right direction of the scanning range with respect to the distance range. For example, if the output unit 105 acquires, from the region of interest, a distance that corresponds to the distance range D in which the object 99 is present, as in the example illustrated in FIG. 3, the output unit 105 references the calibration table, and determines and outputs the calibration parameter for scanning over the scanning angle range from −33.172 to 26.417 (deg) while changing the angle in increments of 0.03104 deg per pixel. The LiDAR 300 uses the outputted calibration parameter to reconfigure the distance measurement condition (step S21). Specifically, in the reconfiguring, since the outputted calibration parameter corresponds to the left and right edges in the field of view of the camera, the portion that corresponds to the region of interest within the field of view is determined as the scanning range for the region of interest. In this way, the controller 100 outputs the determined scanning range for the region of interest to the LiDAR 300, and controls the scanning range of the LiDAR 300.

Thereafter, the LiDAR 300 scans the determined scanning range for the region of interest, and thereby re-measures the distance to each point for the region of interest (step S22). The re-measurement at this time is not performed at a low resolution as in the pre-measurement, and a distance image containing a number of pixels corresponding to the number of pixels in the image is acquired. Note that when scanning the scanning range for the region of interest in the re-measurement, the LiDAR 300 scans only the scanning range for the region of interest to output a distance measurement result corresponding to the scanning range for the region of interest. Alternatively, in the re-measurement, a wider scanning range may be scanned so as to include the scanning range for the region of interest, and a distance measurement corresponding to the scanning range for the region of interest may be extracted therefrom and outputted.

The display unit 106 displays the image and the distance measurement result acquired in this way (step S23).

### Other Embodiments

The foregoing describes embodiments of the present disclosure, but the present disclosure is not limited to the above embodiments.

For example, the distance measurement apparatus described in the above embodiments may be achieved as a single apparatus provided with all components, and may also be achieved by allocating functions to a plurality of devices and configuring the plurality of devices to cooperate. In the latter case, an information processing device such as a smartphone, a tablet, or a personal computer (PC) may also be used as the device that corresponds to the controller. Also, a camera incorporating the functions of the controller or a LiDAR incorporating the functions of the controller may be included.

In the above embodiments, a process executed by a specific processing unit may also be executed by a different processing unit. Also, the order of the multiple processes may be modified, and multiple processes may also be executed in parallel.

In the above embodiments, each component may be achieved by executing a software program suited to each component. Each component may be achieved as a result of a program execution unit such as a CPU or a processor reading out and executing a software program recorded on a recording medium such as a hard disk or semiconductor memory.

Each component may also be achieved by hardware. For example, each component may also be a circuit (or an integrated circuit). These circuits may constitute a single circuit as a whole, or may be respectively different circuits. Also, each of these circuits may be a general-purpose circuit or a special-purpose circuit.

General or specific aspects of the present disclosure may be implemented as an apparatus, a system, a method, an integrated circuit, a computer program, or a computer-readable recording medium such as a CD-ROM, or any selective combination thereof.

For example, the present disclosure may be achieved as a control method to be executed by a computer, or as a program for causing a computer to execute a control method. The present disclosure may also be achieved as a non-transitory computer-readable recording medium on which such a program is recorded.

Otherwise, embodiments may be obtained by making various modifications that would naturally occur to a person skilled in the art to the foregoing embodiments, and embodiments may be achieved by freely combining the components and functions in the foregoing embodiments without departing from the gist of the present disclosure, but such embodiments are also included in the present disclosure.

The present disclosure is useful for measuring distance in a two-dimensional plane associated with an image.

What is claimed is:

1. A distance measurement apparatus comprising:
a LiDAR that includes a scanner and measures the distance to each point within a scanning range;
a camera that takes an image within an image-taking range that at least partially overlaps the scanning range; and
a controller, wherein
the controller
performs pre-measurement using the LiDAR to acquire the distance of at least one point in a region of interest within the image,
determines a calibration parameter for calibrating the scanning range of the LiDAR based on the distance of the at least one point; and
performs re-measurement using the LiDAR with the determined calibration parameter to acquire the distance to each point in the region of interest.

2. The distance measurement apparatus according to claim 1, wherein
in the determining of the calibration parameter, the controller selects one calibration parameter from a calibration table that includes a plurality of calibration parameter candidates prepared with respect to each distance of the at least one point.

3. The distance measurement apparatus according to claim 1, wherein
the controller further
causes a display to display the acquired image, and
accepts a specification of the region of interest from a user with respect to the displayed image.

4. The distance measurement apparatus according to claim 1, wherein
the pre-measurement is of a lower resolution compared to the re-measurement.

5. The distance measurement apparatus according to claim 2, wherein
the plurality of calibration parameter candidates correspond respectively to a plurality of distance ranges delimited according to the distance of the at least one point.

6. The distance measurement apparatus according to claim 5, wherein
the plurality of distance ranges are such that the shorter the distance from the camera, the narrower the range width.

7. The distance measurement apparatus according to claim 1, wherein
the center of the image-taking range of the camera and the center of the scanning range of the LiDAR intersect at a distance that is equal to or greater than 50 times an installation spacing between the camera and the LiDAR.

8. The distance measurement apparatus according to claim 1, wherein
the at least one point is included in the half of the region of interest that is closer to the LiDAR.

9. A control method for controlling a LiDAR, the LiDAR including a scanner and measuring the distance to each point within a scanning range, the control method comprising:
performing pre-measurement using the LiDAR to acquire the distance of at least one point in a region of interest within an image, the scanning range at least partially overlapping an image-taking range of the image;
determining a calibration parameter for calibrating the scanning range of the LiDAR based on the distance of the at least one point; and
performing re-measurement using the LiDAR with the determined calibration parameter to acquire the distance to each point in the region of interest.
